(19) United States
(12) Patent Application Publication
(10) Pub. No.: US 2009/0234937 A1
(43) Pub. Date: Sep. 17, 2009

(54) OPTIMIZATION IN A COMMUNICATION SYSTEM

(75) Inventors: Soodesh Buljore, Bures Sur Yvette (FR); Matthew J. Dillon, Greenwood Village, CO (US); Elliot M. Stewart, Buffalo Grove, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/372,210

(22) Filed: Feb. 17, 2009

Related U.S. Application Data
(60) Provisional application No. 61/036,132, filed on Mar. 13, 2008.

(51) Int. Cl. G06F 15/177; H04W 4/00

(52) U.S. Cl. 709/220; 370/338

(57) ABSTRACT

A communication system comprises a configuration manager which includes an optimizer for performing a Radio Access Network (RAN) optimization process. An optimization characteristic for the RAN optimization process and operational data for a plurality of remote terminals is determined, and based on this information a grouping processor determines a plurality of groups of remote terminals. A policy processor determines an operational policy for each of the groups in response to the optimization characteristic and the operational data and a policy distributor transmits the operational policy of each group to at least the remote terminals in the group. Each remote terminal then continues to operate in accordance with the operational policy of the group to which the remote terminal belongs. The invention may typically allow improved performance and specifically may allow operation to be adapted to the specific optimization processes being performed. The invention is suitable for a heterogeneous communication system.

### FIELD OF THE INVENTION

The invention relates to optimization in a communication system and in particular, but not exclusively, to optimization in a heterogeneous communication system comprising a plurality of radio access networks using different radio access technologies.

### BACKGROUND OF THE INVENTION

Wireless communication systems are becoming increasingly ubiquitous and are continuously developing to provide improved coverage and services. Currently, the trend is towards integrating different communication systems and standards to provide a more flexible and enhanced seamless user experience.

Specifically, communication systems may comprise a distributed network of heterogeneous Radio Access Networks (RANs) using different Radio Access Technologies (RATs) including for example WiMAX™, WiFi™ (IEEE802.11a/b/g/n, etc.), cellular communication standards (e.g. Global System for Mobile communication (GSM), 3^{rd} Generation Partnership Project (3GPP), etc.), Digital Video Broadcast—Terrestrial (DVB-T), Digital Audio Broadcast (DAB) access networks etc.

In heterogeneous and reconfigurable wireless systems, terminals and network equipment have enhanced capabilities for adapting to the available environment. In particular, the remote terminals served by the access networks typically include reconfigurable multi-mode terminals that are capable of using different wireless access technologies and different RATs.

An example of such a heterogeneous communication system is provided by the P1900 standards series which is being standardized by the Standards Coordination Committee 41 of the Institute of Electrical and Electronic Engineers (IEEE).

Thus, in many such heterogeneous communication systems, each terminal/user can use several strategies for getting the best service requested by the user. Multi-mode and reconfigurable terminals have the capability to connect simultaneously to one or several wireless network resources and also to self-reconfigure in order to connect to a new RAN/RAT available in a cell. Multi-mode and reconfigurable network equipments allow an enhanced capability in either dynamically increasing radio access resources or in reconfiguring nodes to dynamically make new resources available depending on the resource demands in a given area. The multi-mode and reconfigurable terminals preferably automatically adapt to new scenarios.

A critical problem for communication systems, and in particularly for such heterogeneous communication systems, is that of how to adapt the operation to the specific conditions experienced in various locations. Due to the heterogeneous nature of the system, it is generally advantageous to implement a high degree of distribution of decision functionality. For example, it is advantageous that the individual remote terminals to some extent autonomously adapt their operation to the current conditions. However, it is also desirable that the operation of the heterogeneous communication system is at least partly centrally controlled in order to allow an operator to control the operation and to ensure that the communication system as a whole operates satisfactorily. The centralised control also allows the adaptation of the communication system to take into account statistical and non-local parameters.

Accordingly, communication systems may often perform centralised optimisation algorithms in order to improve the performance of the communication system and adapt this to the current conditions. However, such centralised optimisations tend to be resource demanding and in particular tend to introduce a significant signalling overhead resulting in significant amounts of communication resource being used to communicate optimisation related data between the optimisation entity and the remote terminals.

For example, large amounts of measurement data are typically reported from the remote terminals to the optimisation unit in order to ensure that the optimisation algorithm has sufficient data on which to base the optimisation. Furthermore, the communication of control data instructing the remote terminals to adapt their operation to the optimisation results can be resource demanding. Indeed, in many cases the frequency or extent of optimisations performed may be restricted by the communication resource required for fast dynamic adaptation of the operation of the remote terminals.

Indeed, although such problems exist in most communication systems, they are particularly critical in heterogeneous communication systems wherein many different types of RANs and remote terminals must be considered.

Hence, an improved communication system would be advantageous and in particular a system allowing increased flexibility, reduced complexity, reduced resource consumption, reduced communication, facilitated optimisation, improved optimisation and/or improved performance would be advantageous. In particular, a heterogeneous communication system providing one or more of such advantages would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a communication system comprising: a configuration manager comprising: an optimizer for performing a Radio Access Network, RAN, optimization process, a characteristic unit for determining an optimization characteristic for the RAN optimization process, an operational unit for determining operational data for a plurality of remote terminals, a grouping unit for determining a plurality of groups of remote terminals from the plurality of remote terminals in response to the optimization characteristic and the operational data, a policy unit for determining an operational policy for each of the plurality of groups in response to the optimization characteristic and the operational data, and a transmitter for transmitting the operational policy of each group of the plurality of groups at least to remote terminals in the group; and wherein each of the plurality of remote terminals is arranged to operate in accordance with an operational policy of a group of the plurality of groups to which the remote terminal belongs.

The invention may provide an improved communication system. In particular, the invention may in many embodiments provide improved performance of the communication system as a whole, improved optimisation, reduced communication resource usage, improved adaptation of the communication system to the current conditions, facilitated operation and/or implementation. The invention may in particular allow improved and/or facilitated optimisation of a communication system wherein the optimisation operation of the communication system as a whole is adapted to the characteristics of the specific optimisation being performed.

In many embodiments, the system may allow the operation of remote terminals to be partially autonomously adapted by the individual remote terminals while at the same time allowing the operation to be managed centrally to suit the specific requirements and preferences of the RAN optimisation algorithm and the operational conditions. For example, in some embodiments, one or more operational policies may comprise a remote terminal reporting policy. Thus, in some embodiments, the approach may allow the reporting of e.g. measurement data from remote terminals to be flexibly and dynamically adapted to provide data specifically required or desired by the specific optimization algorithm. Furthermore, the data may specifically be provided by a distribution of remote terminals having characteristics associated with particularly relevant data for the optimization algorithm. Specifically, in many embodiments, the approach may allow a prioritized collection of measurement data particularly relevant to the optimization algorithm in view of the current operational characteristics while at the same time allowing a reduction in the quantity of measurement data that is reported.

The operational data may include data relating to the operation of the remote terminals in the communication system. The data may e.g. include data reflecting current or previous remote terminal configurations, remote terminal characteristics, remote terminal locations, communication characteristics, resource usage characteristics etc.

An operational policy may comprise one or more rules specifying an allowed and/or required operation of remote terminals of the group to which the operational policy belongs. A rule may for example specify one or more allowed and/or required remote terminal actions when a set of remote terminal parameters and/or characteristics meet a specific criterion. An operational policy may specify operational boundaries and requirements that must be met while allowing the remote terminal to otherwise autonomously select its operation. Thus, the policy may allow distributed decision making which is constrained by a centrally generated operational policy. Each remote terminal may belong to none, one or more groups. In some embodiments, each remote terminal may only belong to one group, i.e. the groups of remote terminals may be disjoint in some embodiments.

According to another aspect of the invention there is provided a configuration manager for a communication system comprising: an optimizer for performing a Radio Access Network, RAN, optimization process; a characteristic unit for determining an optimization characteristic for the RAN optimization process; an operational unit for determining operational data for a plurality of remote terminals; a grouping unit for determining a plurality of groups of remote terminals from the plurality of remote terminals in response to the optimization characteristic and the operational data; a policy unit for determining an operational policy for each of the plurality of groups in response to the optimization characteristic and the operational data; and a transmitter for transmitting the operational policy of each group of the plurality of groups at least to remote terminals in the group.

According to another aspect of the invention there is provided a method of operation for a communication system, the method comprising: performing a Radio Access Network, RAN, optimization process; determining an optimization characteristic for the RAN optimization process; determining operational data for a plurality of remote terminals; determining a plurality of groups of remote terminals from the plurality of remote terminals in response to the optimization characteristic and the operational data; determining an operational policy for each of the plurality of groups in response to the optimization characteristic and the operational data; transmitting the operational policy of each group of the plurality of groups at least to remote terminals in the remote terminal group; and each of the plurality of remote terminals operating in accordance with an operational policy of a group of the plurality of groups to which the remote terminal belongs.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a heterogeneous communication system in accordance with some embodiments of the invention;

FIG. 2 illustrates an example of a network reconfiguration manager in accordance with some embodiments of the invention;

FIG. 3 illustrates an example of a policy description; and

FIG. 4 illustrates an example of a method of operation for a communication system in accordance with some embodiments of the invention.

### DETAILED DESCRIPTION OF SOME EMBODIMENTS OF THE INVENTION

The following description focuses on embodiments of the invention applicable to a heterogeneous communication system, and in particular to a heterogeneous communication system in accordance with the IEEE P1900 standards. However, it will be appreciated that the invention is not limited to this application but may be applied to many other communication systems including for example homogeneous cellular communication systems, such as a Global System for Mobile communication or a Universal Mobile Telecommunication System communication system.

The IEEE 1900 standard series comprises a number of different Working Groups defining different aspects of the system. In particular, the architecture of P1900 systems is defined in IEEE P1900.4: Architectural Building Blocks Enabling Network-Device Distributed Decision Making for Optimized Radio Resource Usage in Heterogeneous Wireless Access Networks.

The field of application of the IEEE P1900.4 standard is radio systems forming a composite Radio Access Network (RAN). In particular, the composite RAN is formed by a plurality of RANs typically using different Radio Access Technologies (RAT). The end-user terminals are typically multimode terminals, supporting several RATs, with multi-radio link capabilities and having cognitive radio capabilities. The composite RAN is assumed to be operated by either a single or several operators. Within this field of application, the standard provides common means to improve overall composite capacity and quality of service through distributed optimization of the usage of radio resources offered by the composite radio access network.

In a P1900 system, optimization relies on a collaborative information exchange between the composite network and the remote terminals. For this purpose, two entities are identified to facilitate this collaboration: a) a Network Re-configuration Manager (NRM) which is a logical entity that covers a set of RANs in a region (and, therefore, a set of RATs—namely those offered by the RANs in the region) and b) a Terminal Re-configuration Manager (TRM) which is a logical entity per terminal. The NRM, which may be implemented in a distributed manner, is connected to the appropriate elements of the RANs via a Data Communication Network (DCN).

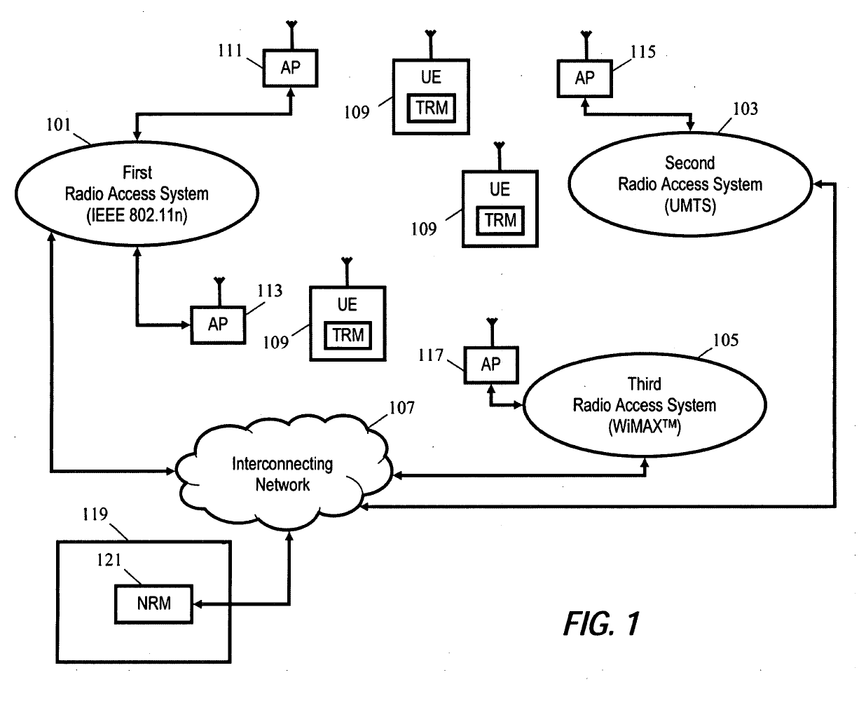

FIG. 1 illustrates an example of a heterogeneous communication system in accordance with some embodiments of the invention. In the specific example, the communication system is an IEEE P1900 heterogeneous communication system. The heterogeneous communication system comprises a plurality of different RANs 101, 103, 105. In the example, each of the RANs 101, 103, 105 is an independent communication system capable of fully supporting communication services independently of other RANs 101, 103, 105. Also, in the example, the communication system comprises heterogeneous Radio Access Technologies (RATs) and in particular the air interface technology used by each RAN 101, 103, 105 is different. Thus, in the example each of the RANs 101, 103, 105 operates in accordance with a different communication standard which may include for example standards such as WiMAX™, WiFi™ (IEEE802.11a/b/g/n, etc.), cellular communication standards (e.g. GSM, 3GPP etc.), DVB-T, DAB etc.

FIG. 1 illustrates a first RAN 101 which is a WiMAX™ communication system, a second RAN 103 which is a cellular UMTS system and a third RAN 105 which is an IEEE 802.11n communication system. In the example, the RANs 101, 103, 105 are coupled together via an interconnecting network 107 that allows data to be exchanged between the different RANs 101, 103, 105. The interconnecting network 107 may be a complex network comprising routing functionality etc or may e.g. be a simple network providing a direct data connection between different RANs 101, 103, 105. Each of the RANs 101, 103, 105 comprises interworking functions allowing communication with the interconnecting network 107 and/or with other RANs 101, 103, 105. Thus, the system allows interaction between the different RANs 101, 103, 105 and for example allows communication between remote terminals supported by different RANs 101, 103, 105 or may allow a communication service to be supported by any one or more of the RANs 101, 103, 105.

FIG. 1 also illustrates remote terminals 109 which are arranged to communicate using one or more communication services of one or more of the RANs 101, 103, 105. The remote terminals 109 may e.g. be end-user terminals, subscriber units, user equipments, mobile phones, PDAs, laptops or any other communication entity capable of communicating over the air interface of one or more of the RANs 101, 103, 105. In the system, each of the RANs 101, 103, 105 comprises a number of access points 111-117 which support communications over the air interface in accordance with the air interface standards of the individual RAN 101, 103, 105. The access points 111-117 may for example include wireless IEEE 802.11n access points 111, 113 of the first RAN 101, Node Bs (base stations) 115 of the second RAN 103 and wireless WiMAX™ access points 117 of the third RAN 105. Indeed the access points 111-117 may be any functional entity allowing a remote terminal to access any of the RANs over the air interface.

The system furthermore comprises a configuration manager 119 which is coupled to the interconnecting network 107 and which is arranged to control and optimise the operation of the communication system. In particular, the configuration manager 119 comprises a Network Reconfiguration Manager, NRM, 121 comprising the functionality specified for NRMs in the IEEE P1900 standards. The NRM is a P1900 entity that manages the composite wireless network and terminals for network-terminal-distributed optimization of radio resource and spectrum usage. The NRM specifically performs various optimization algorithms in order to determine a preferred operation of the communication network and the remote terminals 109. Based on the optimization algorithms, a set of policies are generated and distributed to the remote terminals 109. The user terminals 109 may then autonomously and individually select how to operate depending on the specific characteristics of the remote terminal 109 and of the local context of the remote terminal 109. However, this autonomous adaptation is constrained by the policy generated by the NRM 121 thereby ensuring that the overall performance of the system is controlled by the NRM 121. Specifically, the NRM 121 is arranged to perform the functions of i) Policy Derivation ii) Policy Efficiency Evaluation, iii) RAN Selection, iv) Network Reconfiguration Decision and Control, and v) Spectrum Assignment. These functions are mainly related to decision making and reconfiguration aspects in order to control the overall operation of the composite communication system.

The remote terminals 109 are reconfigurable remote terminals which can adapt their operation to the specific requirements and conditions currently experienced by the remote terminals 109. In the example, the remote terminals 109 are software definable radios which can change their configuration and operation to communicate over at least two of the RANs 101, 103, 105. Furthermore, the remote terminals 109 can reconfigure their operation depending on the specific characteristics of one or more of the RANs 101, 103, 105. For example, it may adapt the used resource from each RAN 101, 103, 105 depending on the loading and resource availability of each RAN 101, 103, 105.

Each of the remote terminals 109 comprises a Terminal Re-configuration Manager (TRM). The TRM is a P1900 entity that manages the terminal for network-terminal-distributed optimization of radio resource and spectrum usage. The TRM may specifically control and configure the operation of the remote terminals 109 within a framework defined by the NRM in a consistent manner using e.g. user preferences, available context information, radio resource usage constraints etc. Specifically, the TRM is capable of reconfiguring the operation of the individual remote terminal 109 in response to information received from the NRM. In addition, the TRM is capable of generating and transmitting terminal-related context information to the NRM 121. This information may for example include required QoS levels, the terminal's capabilities, terminal-related measurements, geo-location information and other terminal-related context information. Thus, in the heterogeneous communication system, the remote terminals and network equipments have enhanced capabilities for adapting to the available environment. Such adaptation may include the modification and reconfiguration of the remote terminals to enable new capability and functionality as well as an adaptation of the operational procedures, such as resource allocation/request procedures.

A problem in systems such as that of FIG. 1 is that the dynamic optimisation of the communication system tends to result in a high resource usage. For example, in order for centralised optimisation algorithms to be efficiently performed, it is critical that sufficient data is available to the optimisation process. For example, measurement data for measurements performed at the remote terminals 109 must be provided to the optimisation algorithm thereby typically resulting in a high resource usage simply in order to communicate the measurement data. Furthermore, measurement operations tend to use terminal resource including computational and battery resources. Also, policy distribution and control can be resource demanding and can result in a reduction of the total capacity of the communication system.

In the system of FIG. 1 the operation of the system is dynamically adapted to current conditions and in particular the system is arranged to adapt the operation of the system to suit the specific optimisation algorithm(s) that is(are) performed. For example, the system may be arranged to scale the policy delivery and measurement collection according to optimization objectives or criteria. In addition, historical operational data is used to adapt the operation of the system not only to the specific characteristics of the optimization but also to the operational characteristics of the system including for example location and communication resource usage distributions of remote terminals. This can specifically create efficient feedback loops for optimization data collection wherein e.g. the information gathering for an optimization algorithm is adapted in response to previously gathered information. The system may for example allow the policy delivery to TRMs to be customized to the individual optimization algorithm and the individual terminals/TRMs can be targeted for given operational policies.

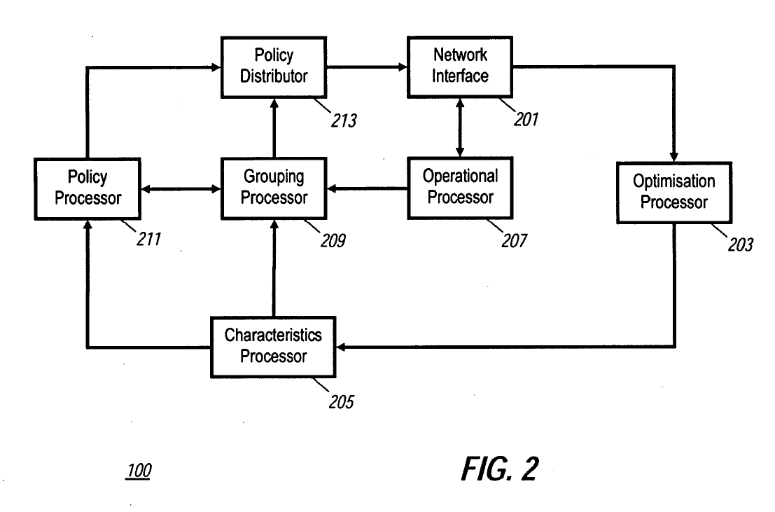

FIG. 2 illustrates the NRM 121 of FIG. 1 in more detail. The NRM 121 comprises a network interface 201 which is arranged to couple the NRM 121 to the interconnecting network 107. Specifically, the network interface 201 can setup and support Radio Enablers (REs) which is a logical communication channel between an NRM and a TRM in order to enable communication between the NRM 121 and the TRMs of the remote terminal subset 109. The REs may be mapped onto one or several RANs already used for data transmission (in-band channel) and/or onto one or several newly defined, dedicated RANs (out-of-band channel).

The NRM 121 furthermore comprises an optimization processor 203 which is capable of performing RAN optimization processes. Thus, the optimization processor 203 can execute a RAN optimization algorithm that may result in the operation of the composite RAN being modified. The optimization algorithm may for example be an air interface resource optimization, a frequency planning optimization, a RAN selection optimization etc.

The optimization processor 203 is coupled to a characteristics processor 205 which is arranged to determine an optimization characteristic for the optimization process. For example, the characteristics processor 205 can evaluate an input data requirement or preference for the optimization process. E.g., for each optimization process that may be performed by the optimization processor 203, the characteristics processor 205 may access a look-up table that specifies which measurement data is desired from the remote terminals 109. For example, for an air interface resource optimization process, the characteristics processor 205 may determine that measurement data is predominantly desired from remote terminals 109 with high communication volumes and for remote terminals 109 evenly distributed over the whole supported area.

The NMR 119 furthermore comprises an operational processor 207 which is coupled to the network interface 201 and which is arranged to determine operational data for a plurality of remote terminals 109. The operational data may include data relating to the operation of the remote terminals 109 in the communication system. The data may e.g. include data reflecting current or previous remote terminal configurations, remote terminal characteristics, remote terminal locations etc. In the example, the operational processor 207 collects data for remote terminals 109 indicating their geographical location and communication volume. It will be appreciated that the data may e.g. be provided directly by the remote terminals 109 and/or may be obtained from operation and management functionality of the individual RANs.

The operational processor 207 and the characteristics processor 205 are furthermore coupled to a grouping processor 209 which is arranged to determine a plurality of groups of remote terminals from the remote terminals 109 in response to the optimization characteristic and the operational data. Thus, the grouping processor 209 can divide the remote terminals 109 into different groups reflecting e.g. a desired distribution of characteristics associated with the remote terminals of the group. As a simple example, based on the optimization characteristic, the grouping processor 209 may determine a requirement for a first group of remote terminals 109. For example, the optimization characteristic may indicate that the current optimization algorithm seeks to achieve a more even distribution of air interface usage across the different RANs 101-105 and that it accordingly is desirable for the optimization process to have information from high volume remote terminals evenly spread across the different RANs 101-105 and across a given geographical area.

Furthermore, based on the optimization characteristic it may be determined that the amount of resource reallocation that can be performed is limited by a maximum amount and accordingly the grouping processor 209 may seek to select a subset of remote terminals 109 such that this group comprises remote terminals 109 that are predominantly high volume users (such that fewer remote terminals 109 need to change RAN).

The grouping processor 209 may then proceed to evaluate the operational data to select the specific remote terminals that should be included in the first group such that these requirements are met. As a simple example, for each geographical area of, say, 500 m radius, the N remote terminals 109 historically having the highest communication volume may be selected for inclusion in the first group by the grouping processor 209. In the specific low complexity example, only two groups are generated by the grouping processor 209, namely the first group comprising remote terminals 109 of particular interest for the specific optimization process, and a second group comprising the remaining remote terminals 109 of less (or no) specific interest.

The grouping processor 209 is coupled to a policy processor 211 which is arranged to determine an operational policy for each of the groups in response to the optimization characteristic and the operational characteristics. In some cases, the determination of the operational policy for a given group may be implicit by the selection of remote terminals 109 for the group by the grouping processor 209. In the specific example, a different but predetermined measurement policy for the remote terminals 109 may be predefined for the two groups. Specifically, a measurement policy instructing the remote terminals 109 to generate and report a minimum amount of measurements to the NMR 121 may be defined for the first group and a measurement policy instructing the remote terminals 109 not to report any measurements may be defined for the second group.

However, in many scenarios, the policy processor 211 may dynamically generate the policy to match both the optimization process and the operational data. For example, the optimization process may be performed and result in an indication that it is preferable to shift a given communication volume from one RAN to another RAN in a specific geographic location. The policy processor 211 may then proceed to generate an air interface resource policy which increases the bias towards the second RAN for remote terminals 109 in the first RAN. The geographic area in which the bias should be applied is determined from the optimization characteristic in the form of the optimization result. Furthermore, the amount of bias introduced by the policy may be determined based on the number of high volume remote terminals 109 being present within the given area and may thus be determined on the basis of the operational data. For example, for many high volume remote terminals 109 in the area a relatively small bias is introduced such that only a few of the remote terminals 109 switch to the new RAN whereas for a scenario of only few lower volume remoter terminals 109 in the area a relatively high bias is introduced such that a higher percentage of remoter terminals switch to the new RAN.

The policy processor 211 is coupled to a policy distributor 213 which is further coupled to the network interface 201. The policy distributor 213 is arranged to distribute the policies to the remote terminals 109 and may specifically send policies to the TRMs of the remote terminals 109 via suitable REs. The policy distributor 213 specifically ensures that the operational policy for each group is transmitted at least to the terminals in this group. The remote terminals 109 then proceed to operate in accordance with the received operational policy of the group (or possibly groups) to which they belong. Specifically, the remote terminals 109 can proceed to make autonomous decisions but are constrained by the restrictions of the received policy.

In the specific example, the remote terminals of the first group can proceed to generate and report the required minimum measurements to the NRM 121 whereas the remote terminals 109 of the second group will not report any measurements to the NRM 121. Furthermore, after the optimization process has been performed and the air interface resource policy has been distributed to the remote terminals 109, the remote terminals 109 of the first group will proceed to evaluate if they are within the area defined in the policy and if so they will proceed to add the bias towards the second RAN into their RAN selection process.

Thus, the described NRM allows an efficient and flexible adaptation of the operation of the system to the specific optimization processes and the operational conditions. Furthermore, the operation is controlled by flexible policies that allow a significant amount of distributed decision making in the individual remote terminals thereby substantially facilitating and improving management and performance of the system. In particular, the described system allows improved and/or facilitated performance in a heterogeneous communication system with a composite RAN as it facilitates interworking between different RANs.

In some embodiments, the NMR 121 may be arranged to control the remote terminal reporting and specifically the reporting of measurement data. Specifically, in some embodiments, the policy processor 211 is arranged to generate one or more remote terminal reporting policies. For example, the reporting policy for a given group of remote terminals may specify which data should be reported and when this data should be reported. For example, the policy may specify how frequently location data for the remote terminals of the group should be reported, whether remote terminal capability information or current operational modes should be reported etc.

In the specific example, the remote terminal reporting policy can comprise a remote terminal measurement data reporting requirement. For example, the policy can specify that all remote terminals belonging to the group to which the policy applies should report specific measurement data whenever they are within a specific area, at certain intervals, with a certain accuracy etc. Specifically, the characteristics processor 205 can determine a reporting data set that is preferred by the RAN optimization process being performed by the optimization processor 203. Thus, the preferred reporting data set may indicate the required or desired input data for the optimization process provided by the remote terminals. For example, if the optimization is a frequency planning optimization following the addition of an extra carrier to a specific access point 117, the characteristics processor 205 can determine that the optimization process is particularly dependent on resource usage and signal level measurements performed by remote terminals 109 in the local area of this access point 117. However, if the optimization process seeks to optimize a resource distribution between two RANs 101, 103, the preferred data set may be communication volume data and dropped call data from high volume users in the entire geographical area covered by the two RANs. Thus, the characteristics processor 205 can specifically determine the preferred reporting data set dependent on the type of optimization which is performed by the specific optimization process.

The grouping processor 209 can then proceed to select the groups such that at least one group can provide the desired reporting data. For example, a first group may be generated to comprise all remote terminals 109 in a relatively small area around the access point 117 having an added carrier or to comprise all remote terminals 109 capable of being supported by the two specific RANs 101, 103 and having historical communication volumes above a given threshold. The policy processor 211 can then proceed to determine the remote terminal reporting policy for the first group such that the preferred reporting data set is provided to the optimization process.

It will be appreciated that in some embodiments, the preferred reporting data set can comprise an indication of a preferred distribution of remote terminal characteristics for remote terminals providing reporting data. For example, the preferred reporting data set can indicate that reporting data is more important for high communication volume remote terminals than for low communication volume remote terminals or that reporting data is desired for at least 80% of high communication volume remote terminals and for at least 90% of a given geographical area.

Thus, the preferred distribution of remote terminal characteristics can include a bias towards reporting data from remote terminals having characteristics meeting a criterion. For example, it can indicate that reporting data from high communication volume remote terminals 109 is preferred relative to reporting data from low communication volume remote terminals 109. It will also be appreciated that in some embodiments, the reporting policies may not be simple criteria specifying when or what each individual remote terminal should report but may for example comprise a bias or parameter that can be used by each individual remote terminal to determine whether to report specific data. For example, the policy may specify that each remote terminal should apply a stochastic determination of whether to report or not. The policy can then specify that the probability of reporting should be dependent on a given parameter, e.g. the higher the communication volume, the higher the probability of the remote terminal reporting etc. Thus, the preferred distribution of remote terminal characteristics comprises a bias towards measurement data from remote terminals having characteristics meeting a criterion.

The described system may thus substantially reduce the amount of reporting without degrading the quality of the optimization. Specifically, by introducing data collection feedback loops wherein remote terminal usage patterns and specific optimization algorithms are considered when determining what reporting is required from the remote terminals, a substantially reduced communication overhead can be achieved. The data requested from the remote terminals can be customized to meet the needs of the various optimization processes. In this way, the amount of requested data can be substantially reduced while still allowing the statistical requirements for the data collection to be met.

The approach exploits that different optimization algorithms have different data requirements. For example, for a new cell, a new neighbor lists and antenna optimization is required soon after the cell has been introduced to the system. In order to achieve a quick optimization, remote terminals in this local area can have their logging level increased, e.g. the logging and reporting of call detail records may be increased, the sample size for radio environment measurements may be increased (e.g. from 10 to 100 reports) for all calls, the log file may be reported more frequently etc.

As described in the examples above, the operational data may comprise location data which is indicative of locations of at least some of the plurality of remote terminals. This may allow the NRM 121 to perform a location based adaptation of the operation for the specific optimization process. For example, the location data can reflect location information at different levels of granularity including at Location/Routing Area LAI/RAI level, cell level or at e.g. latitude/longitude level. As another example, each remote terminal 109 can comprise a GPS location receiver and the NRM 121 can request that the remote terminals 109 report their location at suitable intervals. For example, the NRM can request information of visited locations from the TRMs of the remote terminals 109. The NRM 121 can then use such location profiles to target suitable remote terminals 109 for measurement collection. Thus, the system may allow an intelligent location sampling of measurements which is particularly suitable for the specific optimization algorithm.

Also, as described in the examples above, the operational data may be volume data indicative of communication volumes of at least some of the plurality of remote terminals. For example, a historical communication resource usage may be measured by the TRMs and reported to the NRM 121. The communication resource may e.g. be given as a data volume communicated within a given time interval and may e.g. be indicated by call minutes and or an amount of data bytes transferred over the air interface. This communication volume information may e.g. be used to select measurement data from specific remote terminals 109 and thus the system may allow an intelligent communication volume based measurement sampling which is particularly suitable for the specific optimization algorithm.

In some embodiments, one or more of the operational policies may be a remote terminal communication resource selection policy. Thus, in some embodiments, the NRM may control the application of resource selection policies based on the specific operational data and optimization process. For example, air interface resource decisions made by the individual remote terminals 109 may be adapted in accordance with different resource selection policies that are selectively applied to different remote terminals 109. For example, one policy may be applied to high communication volume remote terminals in a specific geographical area, another policy to all low communication volume remote terminals, a third to high communication volume remote terminals in other geographical areas and using a specific RAN etc.

Specifically, at least one of the policies can include a RAN selection policy. Thus, each remote terminal 109 may individually select a RAN for a communication service. However, this selection is subject to a RAN selection policy which is provided by the NRM 121. Thus, by distributing differentiated RAN selection policies to different groups depending on operational data and specific RAN optimization processes, a more effective usage of the different available RANs 101-105 can be achieved thereby increasing the performance and capacity of the communication system as a whole.

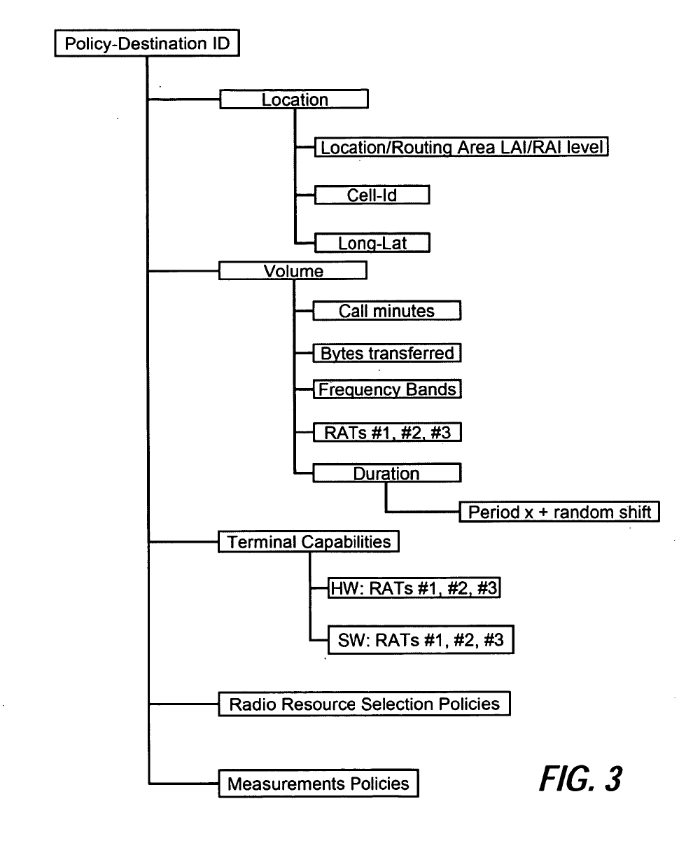

It will be appreciated that in different embodiments, different definitions and descriptions may be used for the generated operational policies. An example of a policy description structure is provided in FIG. 3. In the example, the policy description comprises both data describing the characteristics of the remote terminals 109 to which the policy applies, such as a location criterion, a volume criterion and a terminal capability criterion. This data may specifically be considered to describe the group of remote terminals to which the specific policy description applies.

In addition, the policy description comprises data defining the policy itself. In the specific example, the operational policy comprises both a radio resource selection policy and a measurement policy. The policies include one or more rules for how the remote terminal may, shall or must not operate i.e. one or more restrictions on the operation. For example, such a restriction could be a requirement that when a specific set of circumstances are met, the remote terminal must or must not perform a specific action. Specifically, a policy may describe operational constraints within which the remote terminals may automatically select its operation. In some embodiments, a policy may provide a selection bias for a remote terminal based selection process for selecting an operational characteristic of the remote terminal.

It will be appreciated that in different embodiments different means and approaches may be used to distribute the policies to the different groups of remote terminals. For example, in some embodiments, the policy distributor 213 may transmit the operational policy of a given group only to the remote terminals that belong to this group. For example, the policy distributor 213 may for each policy compare the remote terminal characteristics associated with the policy to the corresponding characteristics of the remote terminals 109 and select the specific remote terminals 109 for which these criteria are met. E.g. for the example of FIG. 3, the location, volume and capability criterion may be evaluated to select the remote terminals 109 to which the policy applies. The policy may then be sent directly to only these remote terminals 109. In such an example, only the policy data itself need to be transmitted thereby allowing a reduced communication resource usage.

It will be appreciated that in some embodiments, the group of remote terminals 109 belonging to a group of a specific policy may simply be identified by the grouping processor 209. In some embodiments, the policy distributor 213 may be arranged to distribute a given policy to more remote terminals 109 than belong to the group of the policy. For example, the policy distributor 213 may cause all policies to be indiscriminately broadcasted to all remote terminals 109 by all RANs 101-105. In such embodiments, the distributed operational policy may comprise an identification of the remote terminal characteristics of the remote terminals of the group associated with the policy. Thus, for the example of FIG. 3, the broadcast policy data will not only comprise the policy data itself but also the location, volume and terminal capability data specifying the remote terminals 109 to which the policy applies.

The remote terminals 109 may then individually compare their characteristics to the characteristics specified by the policy and may determine that they belong to the group associated with the policy if these characteristics match. Thus, the individual remote terminal 109 proceeds to apply any broadcast policy for which its characteristics meets the criteria defined in the received policy data. An advantage of such an approach is that the NRM does not need to have information of the individual remote terminal characteristics but can allow a distributed and autonomous decision of which policies to apply to be made by the individual remote terminal.

In some embodiments, the policy distributor 213 may select a subset of RANs for communicating the operational policy of one or more of the groups depending on the optimization characteristic and/or the operational data. Specifically, the policy distributor 213 may be arranged to select one or more RANs used to communicate with the remote terminals 109 of a group associated with a given policy. For example, if the optimization is a frequency (re)planning optimization following the addition of a new carrier to a cell of a cellular communication system, the policy distributor 213 may select to broadcast the associated policies only via the cellular communication system, as the relevance of remote terminals 109 not having capability of receiving such broadcasts is low.

As another example, the operational data may be evaluated to identify which remote terminals 109 can be reached via which RANs 101-105. For example, if almost all remote terminals of a specific group can currently be reached via two specific RANs (e.g. 101, 103), the policy distributor 213 can decide that only these two RANs 101, 103 should broadcast the policy. Such an approach may allow a more efficient usage of the communication resource and may specifically reduce the overhead associated with distribution of the generated policies.

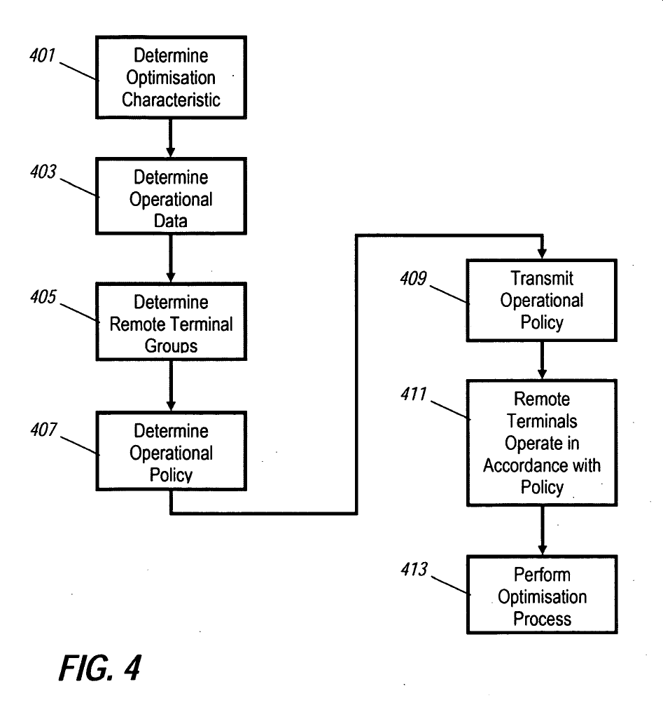

FIG. 4 illustrates a method of operation for a communication system. The method initiates in step 401 wherein an optimization characteristic for a RAN optimization process is determined. Step 401 is followed by step 403 wherein operational data for a plurality of remote terminals is determined. Step 403 is followed by step 405 wherein a plurality of groups of remote terminals from the plurality of remote terminals is determined in response to the optimization characteristic and the operational data. Step 405 is followed by step 407 wherein an operational policy for each of the plurality of groups is determined in response to the optimization characteristic and the operational data. For example, a measurement reporting policy may be determined.

Step 407 is followed by step 409 wherein the operational policy of each group of the plurality of groups is transmitted to at least the remote terminals in the remote terminal group. Step 409 is followed by step 411 wherein each of the plurality of remote terminals operates in accordance with an operational policy of a group of the plurality of groups to which the remote terminal belongs. For example, the remote terminals may provide measurement data in accordance with the measurement reporting policy. Step 411 is followed by step 413 wherein a Radio Access Network, RAN, optimization process is performed.

It will be appreciated that in other embodiments, the order of the method steps may be different and that some steps may be performed in parallel. It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A communication system comprising:
a configuration manager comprising:
an optimizer for performing a Radio Access Network optimization process,
a characteristic unit for determining an optimization characteristic for the Radio Access Network optimization process,
an operational unit for determining operational data for a plurality of remote terminals,
a grouping unit for determining a plurality of groups of remote terminals from the plurality of remote terminals in response to the optimization characteristic and the operational data,
a policy unit for determining an operational policy for each of the plurality of groups in response to the optimization characteristic and the operational data, and
a transmitter for transmitting the operational policy of each group of the plurality of groups at least to remote terminals in the group;
and wherein each of the plurality of remote terminals is arranged to operate in accordance with an operational policy of a group of the plurality of groups to which the remote terminal belongs.

2. The communication system of claim 1 wherein the operational data comprises location data indicative of locations of at least some of the plurality of remote terminals.

3. The communication system of claim 1 wherein the operational data comprises communication volume data indicative of communication volumes of at least some of the plurality of remote terminals.

4. The communication system of claim 1 wherein at least one operational policy comprises a remote terminal reporting policy.

5. The communication system of claim 4 wherein the remote terminal reporting policy comprises a remote terminal measurement data reporting requirement.

6. The communication system of claim 4 wherein the optimization characteristic comprises an indication of a preferred reporting data set for the Radio Access Network optimization algorithm, and the policy unit is arranged to determine the remote terminal reporting policy in response to the preferred reporting data set.

7. The communication system of claim 6 wherein the characteristic unit is arranged to determine the preferred reporting data set in response to a type of optimization performed by the Radio Access Network optimization process, and the group unit is arranged to select remote terminals for a first group such that reporting data from remote terminals of the first group can provide the preferred reporting data set, and the policy unit is arranged to generate the operational policy for the first group such that the remote terminals of the first group transmit reporting data providing the preferred reporting data set.

8. The communication system of claim 6 wherein the preferred reporting data set comprises in indication of a preferred distribution of remote terminal characteristics for remote terminals providing reporting data.

9. The communication system of claim 8 wherein the preferred distribution of remote terminal characteristics comprises a bias towards measurement data from remote terminals having characteristics meeting a criterion.

10. The communication system of claim 1 wherein at least one operational policy comprises a remote terminal communication resource selection policy.

11. The communication system of claim 1 comprising a composite Radio Access Network, the composite Radio Access Network comprising a plurality of Radio Access Networks and wherein at least some remote terminals of the plurality of remote terminals are capable of communicating over a plurality of the plurality of Radio Access Networks.

12. The communication system of claim 11 wherein at least one operational policy comprises a remote terminal Radio Access Network selection policy.

13. The communication system of claim 11 wherein the transmitter is arranged to select a subset of Radio Access Networks for communication of an operational policy for a first group of the plurality of groups in response to at least one of the optimization characteristic and the operational data associated with remote terminals of the first group.

14. The communication system of claim 1 wherein the transmitter is arranged to transmit a first operational policy of a first group only to remote terminals of the first group.

15. The communication system of claim 1 wherein a first operational policy of a first group comprises a set of remote terminal characteristics associated with remote terminals of the first group, and each of the plurality of remote terminals is arranged to determine if the remote terminal belongs to the first group in response to the remote terminal characteristics.

16. The communication system of claim 1 wherein the communication system is an Institute of Electrical and Electronic Engineers P1900 system.

17. The communication system of claim 1 wherein the configuration manager is an Institute of Electrical and Electronic Engineers P1900 Network Reconfiguration Manager.

18. The communication system of claim 1 where each remote terminal of the plurality of remote terminals comprises an Institute of Electrical and Electronic Engineers P1900 Terminal Reconfiguration Manager arranged to receive an operational policy and to control the operation of the remote terminal in response to the operational policy.

19. A configuration manager for a communication system comprising:
an optimizer for performing a Radio Access Network optimization process;
a characteristic unit for determining an optimization characteristic for the Radio Access Network optimization process;
an operational unit for determining operational data for a plurality of remote terminals;
a grouping unit for determining a plurality of groups of remote terminals from the plurality of remote terminals in response to the optimization characteristic and the operational data;
a policy unit for determining an operational policy for each of the plurality of groups in response to the optimization characteristic and the operational data; and
a transmitter for transmitting the operational policy of each group of the plurality of groups at least to remote terminals in the group.

20. A method of operation for a communication system, the method comprising:
performing a Radio Access Network optimization process;
determining an optimization characteristic for the Radio Access Network optimization process;
determining operational data for a plurality of remote terminals;
determining a plurality of groups of remote terminals from the plurality of remote terminals in response to the optimization characteristic and the operational data;
determining an operational policy for each of the plurality of groups in response to the optimization characteristic and the operational data;
transmitting the operational policy of each group of the plurality of groups at least to remote terminals in the remote terminal group; and
each of the plurality of remote terminals operating in accordance with an operational policy of a group of the plurality of groups to which the remote terminal belongs.
